(19) United States
(12) Patent Application Publication
(10) Pub. No.: US 2015/0257603 A1
(43) Pub. Date: Sep. 17, 2015

(54) COLLAPSIBLE WHISK

(71) Applicant: Robinson Home Products Inc., Williamsville, NY (US)

(72) Inventors: Stuart Harvey Lee, Forest Hills, NY (US); Jochen Schaepers, New York, NY (US)

(73) Assignee: Robinson Home Products Inc., Williamsville, NY (US)

(21) Appl. No.: 14/209,585

(22) Filed: Mar. 13, 2014

(51) Int. Cl. A47J 43/10

(52) U.S. Cl. CPC A47J 43/1093

(57) ABSTRACT

A whisk having a handle with a grip portion, a shaft and a hub attached to the shaft at an end opposite the grip portion, and a series of wires attached to a collar at a first end and attached to the hub at a second end, where the collar is movable along at least a portion of the handle to transform the whisk from an expanded configuration to a collapsed configuration. The second ends of the wires preferably have an angle adjacent to a pivot that attaches the second end of the wire to the hub.

### FIELD OF THE INVENTION

The present invention relates to cooking utensils used in the preparation of food and, more particularly, whisks.

### BACKGROUND OF THE INVENTION

Whisks are well known kitchen tools used for mixing, whipping, blending, smoothing, and otherwise preparing food items for cooking or eating. In this regard, whisks are commonly used to prepare food items such as eggs, whipped cream, cake batter, gravy, etc.

Most whisks consist of a long, narrow handle with a number of wire loops joined at the end with spacing between adjacent wires. The spacing allows the wires to pass through the food item being “whisked” to perform the “whisking” function.

Different shaped whisks have been developed to perform different whisking tasks depending on the particular task and the vessel in which the whisk is being used. The most common shape is that of a wide teardrop, sometimes known as a balloon whisk, which is best suited to use in mixing in bowls since their curved edges conform to a bowl's concave sides. Another common shape for whisks comprises a more cylindrical profile, sometimes known as a French whisk, which is more suited to deep, straight-sided pans and/or smaller vessels.

Of course, the different types of whisks require that the cook have more than one whisk in their kitchen, with the multiple whisks taking up valuable storage space especially in what is often a smaller household kitchen. Additionally, at least the balloon whisk is generally large, so that it alone takes up additional storage space.

Others have attempted to reduce the size of a whisk when not in use. One such attempt is found in U.S. Pat. No. 6,206,561 where the whisk handle is rotated to push the wires into a planar alignment, corresponding to a closed configuration. A similar example is found in U.S. Pat. No. 7,044,631, which describes a whisk with an aligning collar that slides along the wires themselves to bring the wires into a similar planar alignment. Another example is found in U.S. Published Patent Application No. 2013-0044560 where each wire loop is placed on a different ring within the handle so that when the various rings are rotated the wire loops rotate from an open balloon configuration to a closed planar configuration.

In each of these prior art references, however, the whisk wires are flattened into planar alignment corresponding to a closed or storage configuration without making the working size of the whisk smaller. Thus, the transformation from an open configuration to a closed, planar configuration limits the use of the prior art whisks primarily to when the wires are in an open configuration.

In keeping with the deficiencies of the known whisks, a single whisk that can perform in different environments and is more easily stored would provide a more efficient food preparation device and would advance the art.

### SUMMARY OF THE INVENTION

The present invention is directed to a whisk comprising a handle, said handle comprising a grip portion, a shaft and a hub with the hub attached to the shaft at an end opposite the grip portion, a series of wires, said wires attached to a collar at a first end and attached to the hub at a second end, wherein the collar is movable along at least a portion of the handle.

The handle preferably includes a race with a main channel axially aligned with the length of the handle and having one or more perpendicularly aligned stop channels along its length, the stop channels corresponding to at least one of a fully expanded, a partially expanded and a collapsed configuration. A protrusion on the collar, and preferably on the interior wall of the collar, is fit to move within the race, to ensure proper alignment with the wires and to engage the one or more stop channels. The stop channels preferably terminate in a catch to retain the protrusion within the selected stop channel, so that the wires are maintained in the desired configuration when the whisk is in use.

Of course, there may be a plurality of symmetrical races, i.e., identical races on more than one side of the handle, to create a more stable connection if desired. Such use of multiple races anticipates multiple protrusions so that the multiple protrusions move in synchronization in the symmetrical races when the collar with the protrusion is activated to expand and collapse the wires of the whisk.

In the most preferred embodiment, the first end of the wires fit into the collar so that they are disposed axially in line with the handle. The second ends of the preferred wires are formed with a change in direction, or angle, immediately adjacent to where the second end attaches to the hub. The angle is preferably about 90°, or a right angle, which may bend slightly when the whisk is deformed from its collapsed position to its expanded position.

The second end of the wire following the angle is rotationally engaged by the hub to pivotally fix the second end of the wire to the hub. Most preferably, the terminal end at the second end of the wire has an enlarged end, preferably in the shape of a ball, which is engaged by a socket in the hub to permit rotation of the wires in relation to the hub. Of course, the rotational engagement between the second end of the wire and the hub can be formed by any pivot structure, so long as there is rotation of the wires in relation to the hub.

The angle at the second end of the wire, as well as the rotation of the wire at the hub, allows the wires to adjust from a collapsed configuration to the expanded configuration with the bulk of the expansion closer to the second end. The expansion of the wires in the area nearer the second end of the wires allows the whisk of the present invention to change from the shape of a traditional French whisk, being almost cylindrical with only slight curvature at the second end when collapsed, to the shape of a traditional balloon whisk, with the bulk of the expansion closest to the second end, when in its expanded configuration.

### BRIEF DESCRIPTION OF THE DRAWINGS

The attached drawings are intended to better illustrate a preferred embodiment of the present invention without limiting the invention in any manner whatsoever.

FIG. 1 is a side elevation of a preferred embodiment of the whisk of the present invention in its fully expanded configuration.

FIG. 2 is a side elevation of the whisk of FIG. 1 in a fully collapsed configuration.

FIG. 3 is a side elevation of the whisk of FIG. 1 in a partially collapsed configuration.

FIG. 4 is a partial cross sectional side elevation of the whisk of FIG. 1 taken through line A-A shown in FIG. 1.

FIG. 5 is an exploded view of the whisk of FIG. 1.

FIG. 5A is a perspective view of the collar shown in FIG. 5 showing the detent on the interior surface thereof.

FIG. 6 is a partial side elevation of the handle of the whisk of the present invention in the area of the race and with the collar removed.

### DETAILED DESCRIPTION OF THE PREFERRED EMBODIMENT

The following description of the preferred embodiment is presented to describe the present invention without limiting the scope of the appended claims in any manner whatsoever.

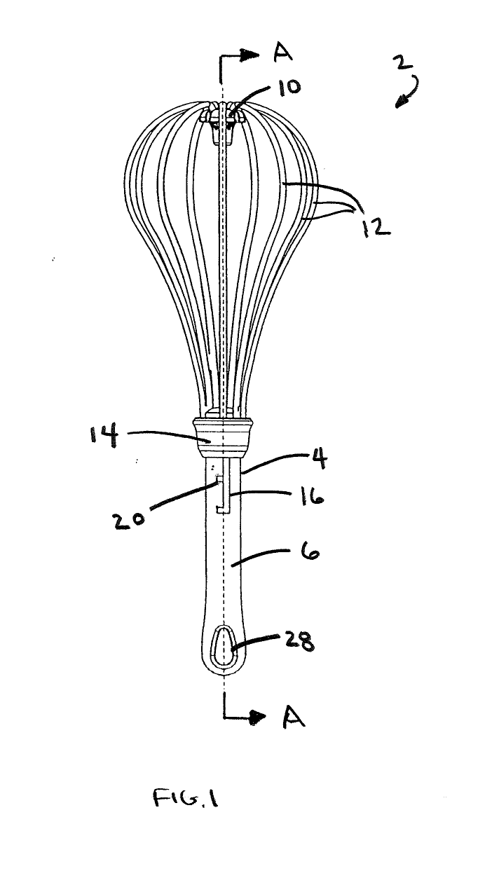

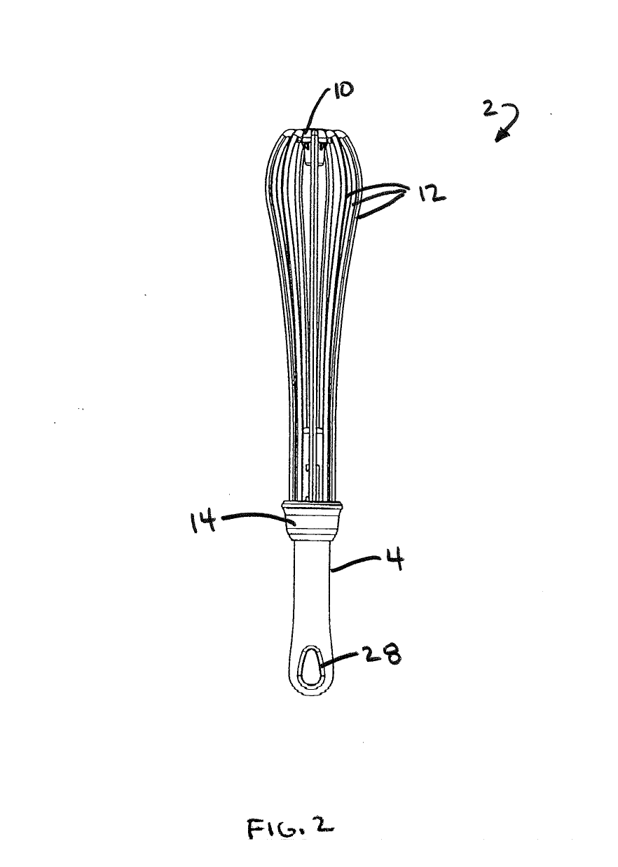

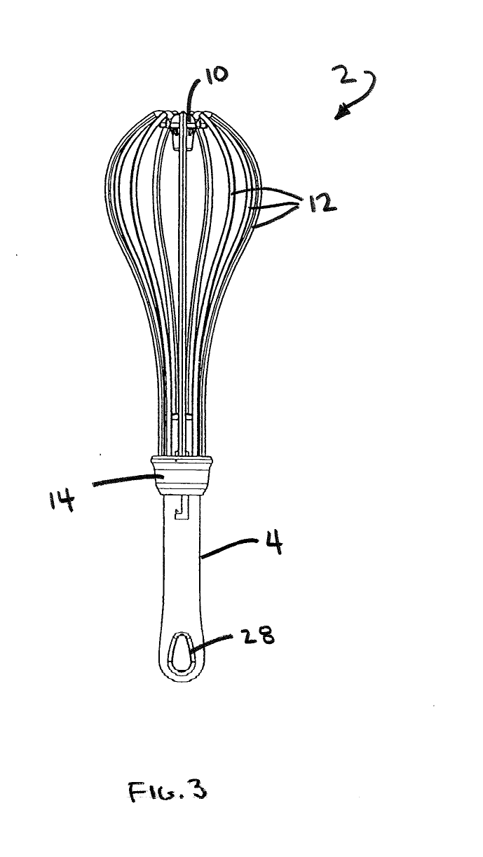

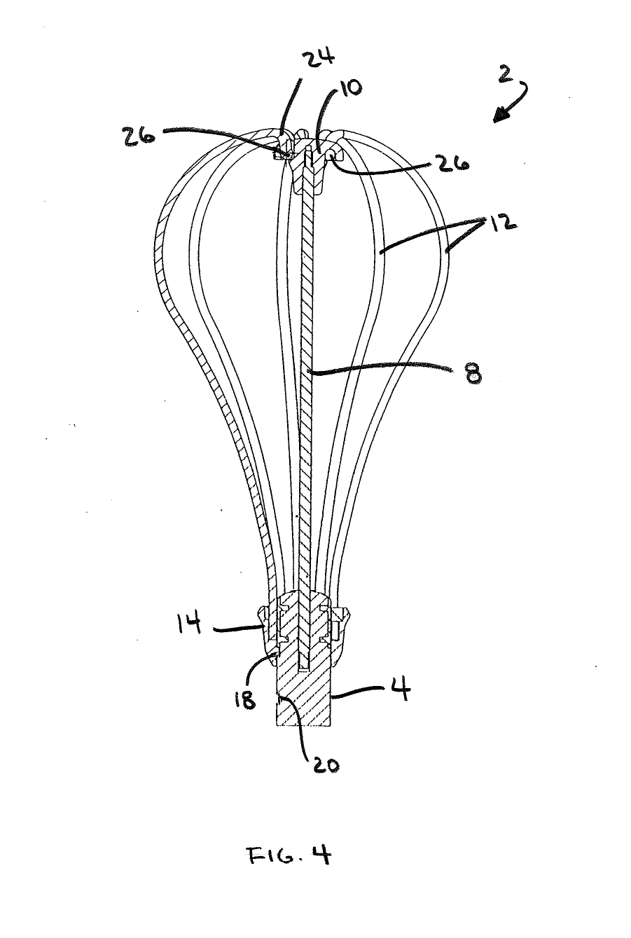

As shown in the accompanying drawings, the present invention is directed to a whisk 2 having a handle 4 comprising a grip portion 6, a shaft 8 and a hub 10, with the hub 10 attached to the shaft 8 at an end opposite the grip portion 6, and a series of wires 12 attached to a collar 14 at a first end and attached to the hub 10 at a second end. The collar 14 is axially movable by sliding along at least a portion of the handle 4 to transform the whisk from an expanded configuration, as shown in FIG. 1, to a collapsed configuration, as shown in FIG. 2, and an intermediate configuration, as shown in FIG. 3.

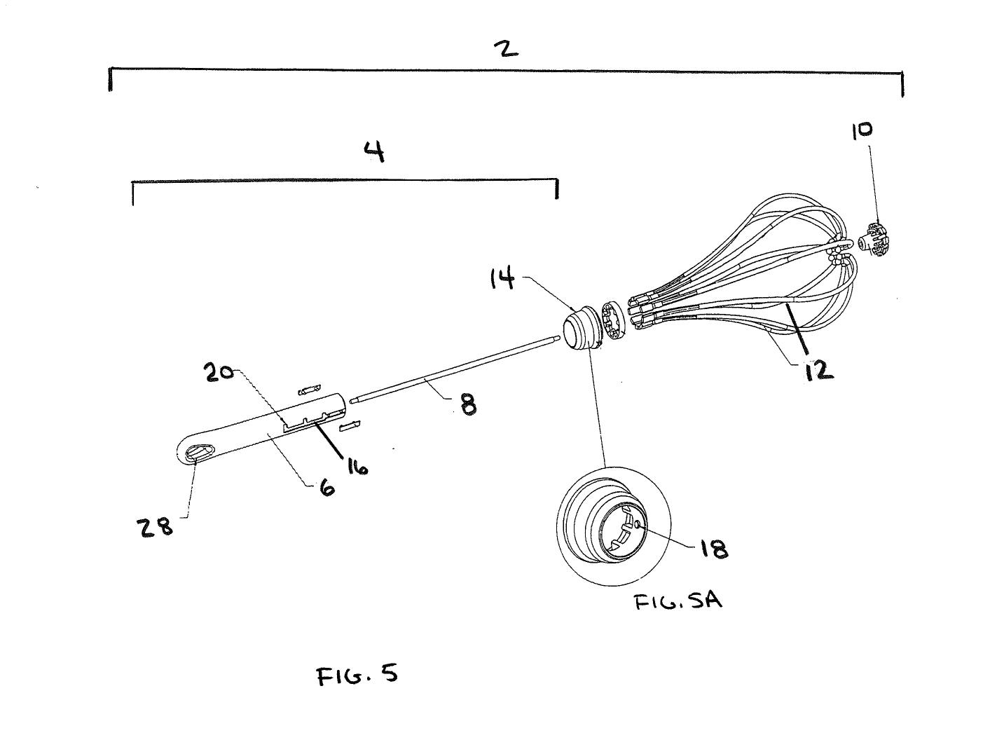

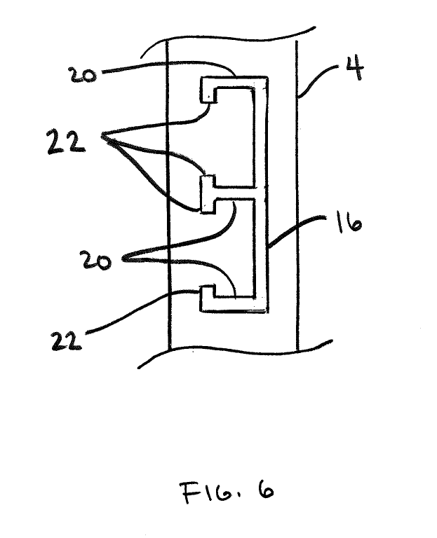

As best seen in FIGS. 5, 5A and 6, the handle 4 includes a race 16 with a main channel that is axially aligned with the length of the handle 4 and guides a protrusion 18 on the interior surface of the collar 14 between the expanded and collapsed configurations. The race 16 is fitted and having one or more perpendicularly aligned stop channels 20 along its length, the stop channels 20 corresponding to the expanded, the collapsed and the intermediate configurations shown.

The stop channels 20 shown in FIG. 6 terminate in a catch 22, formed perpendicular to the stop channels 20, to retain the protrusion within the selected stop channel. Of course, any suitable catch 22 may be used, including such things as cooperating snap in elements, clips, pins, clasps, etc., however, the perpendicular extensions shown have been found to be a suitable catch for the preferred embodiment shown. In this regard, the extensions of the catch 22 may only be in one direction, shown at the top and bottom of the race 16 in FIG. 6, where the tension from the wires 12 maintains the protrusion 18 in the direction of the extension.

The protrusion 18 is also preferably biased into the stop channels 20 by proper alignment of the wires on the collar 14, so that the wires 12 are maintained in the desired, axially aligned configuration when the protrusion 18 is positioned at the terminal ends of the stop channels 20. More particularly, when the protrusion 18 is in the main axial portion of the race 16 the wires 12 are twisted so that they bias the protrusion 18 into the stop channels 20.

The wires 12 of the preferred embodiment shown extend from the top of the collar 14 in substantially axial alignment with the handle 4. Of course, the wires 12 may be fitted to the sides of the collar 14, and may provide rotational grip to activate the collar 14, as a matter of design choice. The second ends of the wires 12 are formed with an angle 24 adjacent the portion of the second end that attaches to the hub 10. The angle 24 is preferably about 90°, but may bend slightly when the whisk 2 is deformed between its expanded position and its collapsed position.

The portion following the angle 24 at the second end of the wires 12 is rotationally engaged by the hub 10 at a pivot 26 that fixes the second end of the wire 12 in rotational relationship to the hub 10. As shown, the terminal end of the wire 12 at the second end has an enlargement, preferably in the shape of a ball, which is rotationally engaged by a socket formed within the hub 10. The pivot 26 formed by the ball at the terminal end of the second end of the wire 12 captured by the socket formed within the hub 10 permits rotation of wire 12 in relation to the hub 10.

Of course, any suitable pivot 26 can be used between the second end of the wires 12 and the hub. For example, the second ends of the wires 12 can be formed in a loop that encircles a ring that is part of the hub 10. Another example would be where the second end of the wires 12 can be in the form of an axel that passes through a hole in the hub 10, the terminal end of the wire 12 being enlarged to keep the end of the wire 12 from disengaging the hole in the hub 10. All such examples, without limitation, may form a suitable pivot 26 for the present invention.

This pivoting of the wire 12 in relation to the hub 10 permits the portion of the second end of the wire 12 between the angle 24 and the enlargement 26 to rock from a more axial alignment with the handle, when in the expanded configuration, to a less axial alignment with the handle, when in the collapsed configuration. As such, the whisk 2 in the expanded configuration more closely resembles the traditional balloon whisk and in the collapsed configuration is more cylindrical, in keeping with the traditional French whisk.

In this regard, it has been found that although the wires 12 can be made out of any suitable material, including stainless steel, silicone coated metal, polymers, etc., a polymer, and specifically nylon, is most preferred. Similarly, the handle 4 can be made out of any suitable materials, with a thermoplastic material being preferred and acrylonitrile butadiene styrene (ABS) being most preferred for the grip portion 6 and stainless steel being most preferred for the shaft 8 and hub 10. The collar 14 is also preferably formed of a thermoplastic material with acrylonitrile butadiene styrene (ABS) being most preferred. FIGS. 5 and 5A provide an illustration of the preferred parts and assembly for the whisk 2 of the present invention.

Of course, the whisk 2 of the present invention may have additional features common to known kitchen utensils, including a hang hole 28 at the terminal end of the grip portion 6 and the like.

Notwithstanding, variations, modifications and alterations to the above detailed description will be apparent to those skilled in the art. All such variations, modifications and/or alternatives are intended to fall within the scope of the present invention, limited only by the claims. All cited patents and publications are hereby incorporated by reference.

We claim:

1. A collapsible whisk comprising a handle, said handle comprising a grip portion, a shaft and a hub with the hub attached to the shaft at an end opposite the grip portion, a series of wires, said wires attached to a collar at a first end and attached to the hub at a second end, wherein the collar is movable along at least a portion of the handle to adapt the whisk from a collapsed configuration to an expanded configuration.

2. The collapsible whisk of claim 1 wherein the collar further comprises a protrusion and the handle further comprises a race in which the protrusion is slideably engaged.

3. The collapsible whisk of claim 2 wherein the race has a main channel which is in axial alignment with the handle.

4. The collapsible whisk of claim 3 wherein the race further comprises one or more stop channels substantially perpendicular to the main channel corresponding to one or more of an expanded configuration, a collapsed configuration and an intermediate configuration.

5. The collapsible whisk of claim 4 wherein one or more of the stop channels terminate in a catch.

6. The collapsible whisk of claim 5 wherein the catch comprises an extension formed substantially perpendicular to the stop channel.

7. The collapsible whisk of claim 1 wherein the first end of the wires are attached to the collar in a substantially axial alignment with the axis of the handle.

8. The collapsible whisk of claim 1 wherein the wires comprise an angle at the second end adjacent the hub.

9. The collapsible whisk of claim 8 wherein angle at the second end adjacent the hub is about 90°.

10. The collapsible whisk of claim 1 further comprising a pivot between the terminal end of the second end of the wire and the hub.

11. The collapsible whisk of claim 10 wherein the terminal end of the second end of the wire comprises an enlargement and the hub comprises a socket with the pivot comprising the enlargement captured by the socket.

12. The collapsible whisk of claim 11 wherein the enlargement at the terminal end of the second end of the wire comprises a ball that is engaged by the socket of the hub.

13. The collapsible whisk of claim 1 wherein the wires are formed from a material taken from the group consisting of stainless steel, silicone coated metal and polyesters.

14. The collapsible whisk of claim 13 wherein the wires are formed from a nylon material.

15. The collapsible whisk of claim 1 wherein at least a portion of the handle is formed of a thermoplastic material.

16. The collapsible whisk of claim 1 wherein the handle further comprises a hang hole.
